(19) United States
(12) Patent Application Publication
(10) Pub. No.: US 2023/0306881 A1
(43) Pub. Date: Sep. 28, 2023

(54) Novel Sign System

(71) Applicant: Leatis Lee Jones, JR., Miami, FL (US)

(72) Inventor: Leatis Lee Jones, JR., Miami, FL (US)

(21) Appl. No.: 17/704,977

(22) Filed: Mar. 25, 2022

(51) Int. Cl. G09F 21/04; G09F 13/18; G09F 7/18; G09F 9/30; G03B 21/58

(52) U.S. Cl. CPC G09F 21/048; G09F 13/18; G09F 7/18; G09F 9/301; G03B 21/58; G09F 2007/1865

(57) ABSTRACT

The present invention is a display system affixed to the side panels of a truck whereby the system includes a cover configured for protecting the display from environmental damage.

### BACKGROUND OF THE INVENTION

Signage displays and advertisements continue to evolve and develop. Purses engaged in the activity are continually seeking novel and innovative systems in order to create noteworthy displays.

One search area that has received increasing development is that relating to displays on motor vehicles. Many people are familiar with trucks and other large vehicles that have customized displays. However, a significant drawback in these customized displays relates to the changing of these displays as desired.

There is a need for a straightforward changeable display for use on motor vehicles.

The present invention addresses this issue.

### SUMMARY OF THE INVENTION

The present invention provides a novel display system configured for use on motor vehicles. In one embodiment, a preferred display includes utilizing the side panels of trucks.

In one embodiment, the present invention is a system for creating static and/or mobile images upon the exterior of vehicles.

In one embodiment, the images are produced by computer-controlled input to an LED/VLED screens.

In one embodiment, the screens are installed as the side panels of a truck In one embodiment, the images are imported, stored and projected by a “control Computer.” The control computer will be able to feed unique inputs to multiple slave monitors

In one embodiment, onsite communication and control is provided by cellphone by onsite operators of the system.

In one embodiment, the physical messages themselves would appear on the led screens by means of wi-fi projection and/or cameras mounted within the vehicles.

The screens themselves be rigid or flexible, both or combinations thereof are contemplated in the present invention.

In one embodiment, the screens are protected by transparent or translucent covers to reduce environmental damage.

In one embodiment, the cameras will provide real-time visual security within the vehicle.

In one embodiment, communication in the system is by Internet and/or satellite TV or by interactive monitors.

As generally understood, the present invention includes use on all types and styles of trucks or transport systems that utilize flat sides including, but not limited to, panel or dry vans, freightliners, hotspots, box trucks, semi-trucks, enclosed trailers, reefers/chiller trucks livestock trucks, Conestoga units, containers and or container system units, and combinations thereof.

The present invention provides product advertisements scaled to fit all sizes of vehicle to maintain continuation of ad format despite vehicle size.

The present invention is used with existing or new vehicle/trucks and is retrofitted to vehicles currently on the road as needed.

In one embodiment, the system is constructed as an attached enclosure system including protective materials, for example, acrylic and the like that provide a protective covering in front and advertisement behind. In one embodiment the display or ad is protected from road debris and hazard being dirt, mud, tearing due to airborne materials, rocks and assorted types of road debris by a protective layer composed of a clear covering of material that allows the display or ad to be read.

In an embodiment where the display is a static display, the display includes vinyl (wraps etc.) paper, paint, acrylic, wool, woven fabric from ELS cotton, expanded polytetrafluoroethylene (sold under the name Gore-tex®), oilcloth, natural rubber, latex, other membraned or coated fabrics, and combinations thereof.

In an embodiment where the display is projected, the displays include, but are not limited to projector or multiple mini projectors that will display flat screen technologies and related systems, liquid crystal displays (LCD), electronic display, LED displays, 4K HD display, and combinations thereof.

In this embodiment, electronic display versions are also configured such that they are removed, replaced or changed/updated/revised on site or on the go as technology evolves.

The invention includes a configuration to update signage/ads remotely via Bluetooth® (or similar) technology so users can update the signs/graphics quickly without having to physically change the ads making this version the most efficient.

Digital ads are configured to be switched out per slot individually per ads via Bluetooth®.

In one embodiment, either of a static display or computer projected display are configured with a of roll down/pull down screen display. The screen will be roll/pull down from the top of the frame and fasten at the bottom of the frame. It is contemplated that the Pull down/Roll down display is provided as a single image or as or it can be slotted to multiple ads (1-5 slots) depending on frame configuration.

The system will have lighting equipped on the framing.

In one embodiment, a static display is attached under the protective cover of the present invention by book and loop fasteners.

Other embodiments include attachment using snaps, clip systems, adhesives, roller systems, cladding, and combinations thereof. In one embodiment of the present invention, it is further contemplated lighting systems are included. Suitable lighting systems include, but are not limited to overhead lighting, backlighting, lighting infused screens, up lighting, and combinations thereof.

In one embodiment the covering includes a framing configuration that varies from a singular slot, up to 2-3 ads configured in a drop-in slot.

The framing will have slots so that the ads will be able to drop into place. The frames are formed of suitable material including, but not limited to aluminum, carbon steel, alloy steel, stainless steel, iron (wrought or cast), magnesium.

Copper, brass, bronze, zinc, wood, or combinations thereof.

In one embodiment, the display is a drop in, and the cover of Plexiglass/Acrylic provides protection from rain, sun, and environmental hazards.

The Panel of the present invention is configured with any one or more of ultra-thin and super-light, easy to install and dismantle, aluminum Panel frame design.

Further, as understood the system provides real time (Live) Advertisement/Image Changeability.

The system has a Wi-Fi/Bluetooth projection control system with high frequency GPS tracking system monitoring Ad locations.

The system display is configured with a high brightness over (5500 nits for daytime and nighttime visibility).

In one embodiment, the system has a multi-screen image projection, displaying 1-3 different images at once.

In one embodiment, the display has reflective stripes.

In one embodiment, the lighting system is positioned on the perimeter of panel design.

In one embodiment, the display is waterproof and also will display during rain/any weather condition.

### BRIEF DESCRIPTION OF THE SEVERAL VIEWS OF THE DRAWINGS

FIG. 1 is a view demonstrating communications in a system according to one embodiment of the present invention.

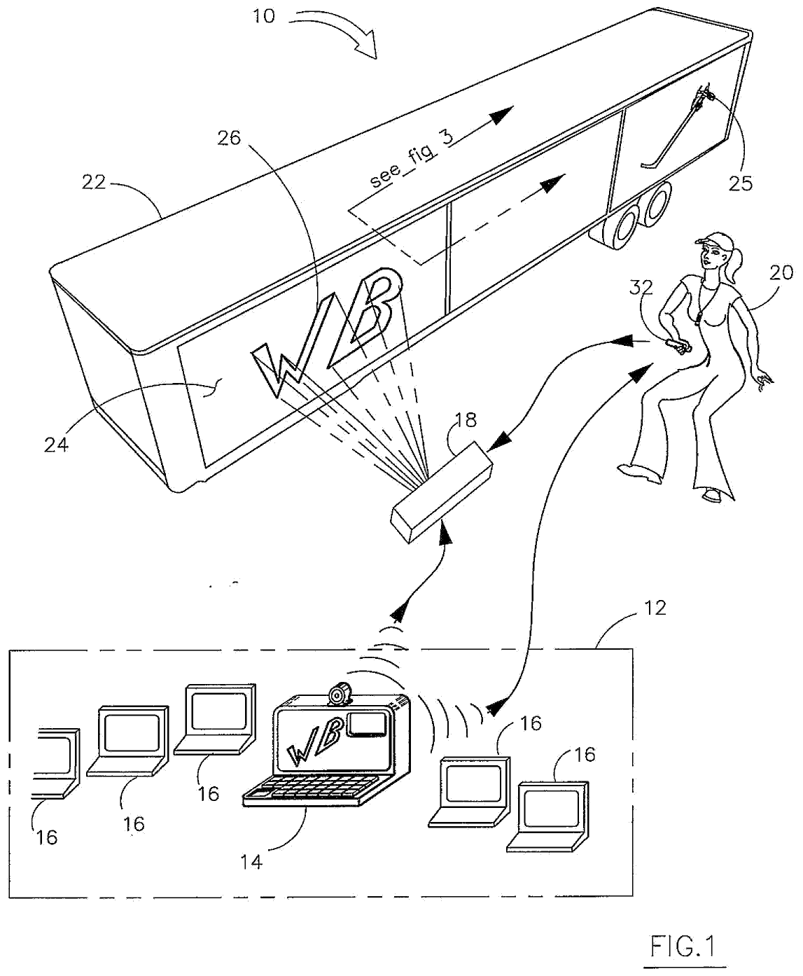

FIG. 2 is a view demonstrating communications according to one embodiment of the present invention.

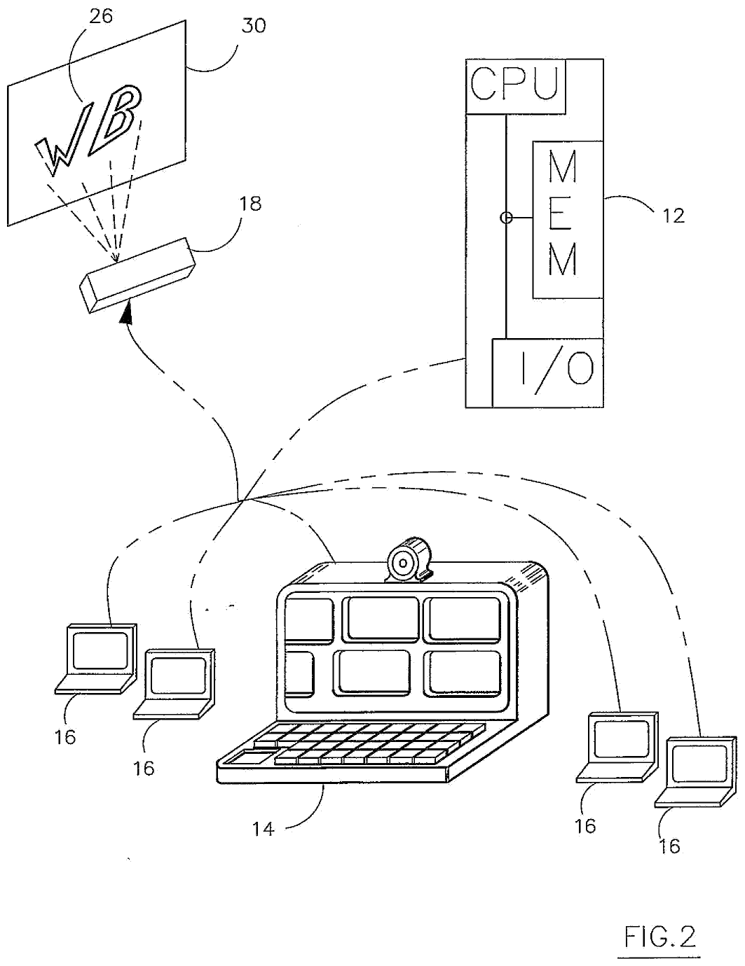

FIG. 3 is a top section view from section lines A-A of FIG. 1 according to one embodiment of the present invention.

FIG. 4 is an enlarged view from the section noted in FIG. 3

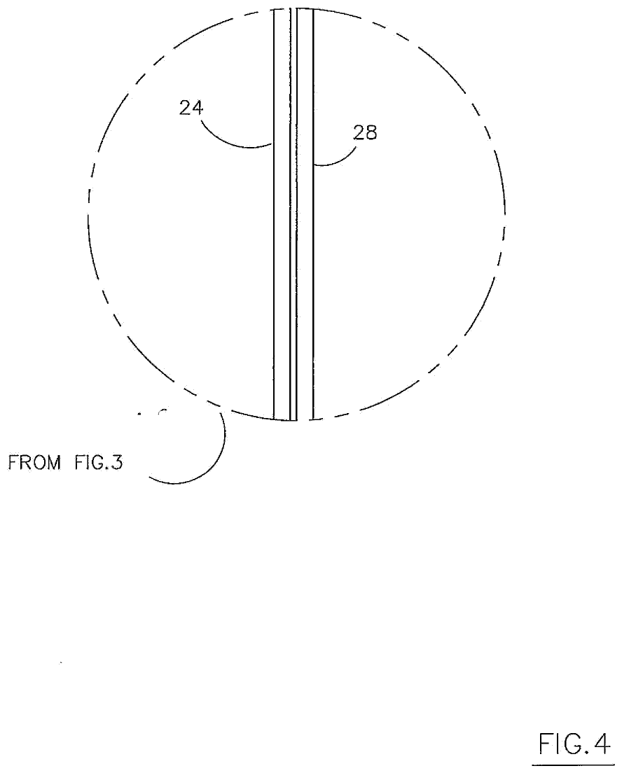

FIG. 5 is a partial cross section side view according to one embodiment of the present invention.

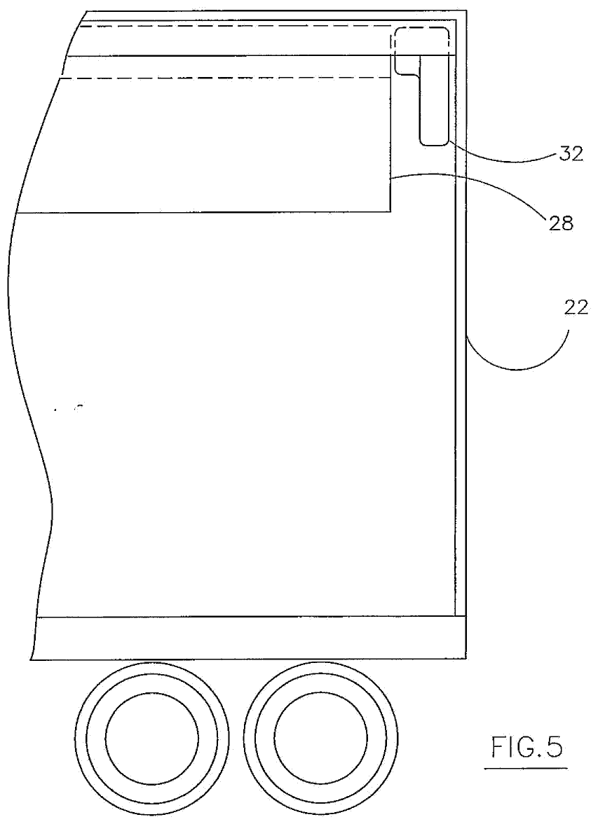

FIG. 6 is a view demonstrating communications according to one embodiment of the present invention.

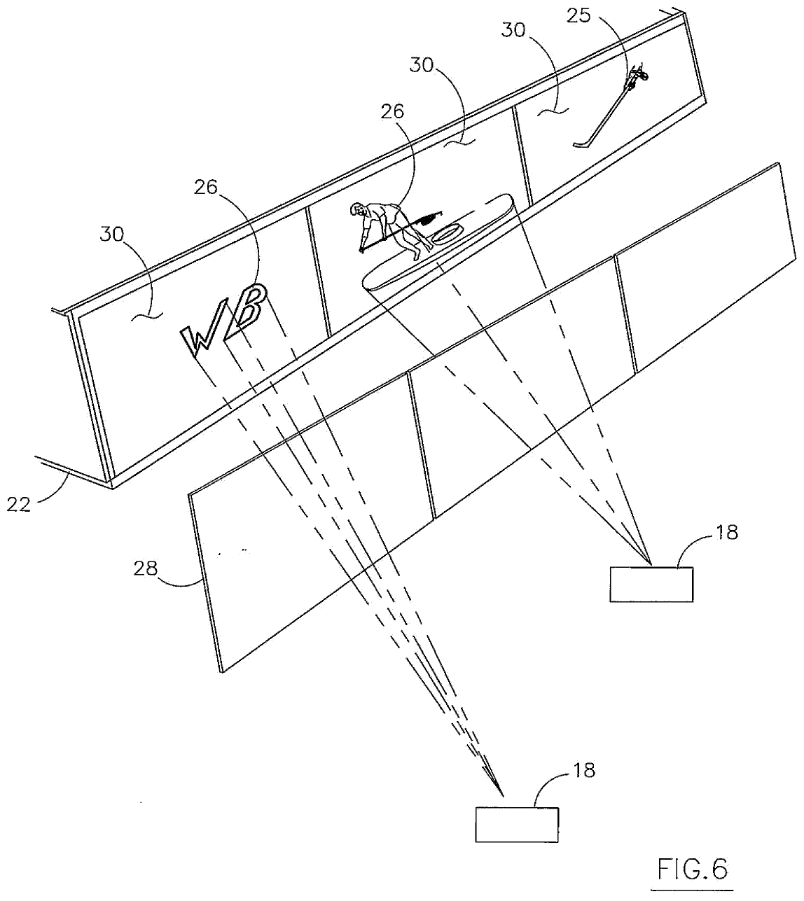

### DETAILED DESCRIPTION OF THE PREFERRED EMBODIMENTS

As generally understood by the figures, System 10 includes a control system 12 having a control computer 14 and at least one slave monitor 16 operatively associated with said control computer 14. As generally understood in the art, control 14 is configured to communicate with image protector 18. In one particular embodiment, a system operator 20 will utilize a handheld computing device 30 to switch devices including cell phones, smart phones, tablets, and the lake, we are inside handheld computing device is operatively associated with control computer 14 versus allowing an on-site operator 20 the ability to control system 10.

In one embodiment, vehicle 22 has projection area 24 in which projected image 26 is configured to display images ultimately from control computer 14.

In another embodiment, a printed display 25 is utilized on the side of vehicle 22.

System 10 of the present invention further includes a safety covering 28 that protects either of projection screen 30 or printed display 25 from environmental elements.

One embodiment, the system includes a gear motor 34 constructed and arranged to raise and lower screen 30 as desired.

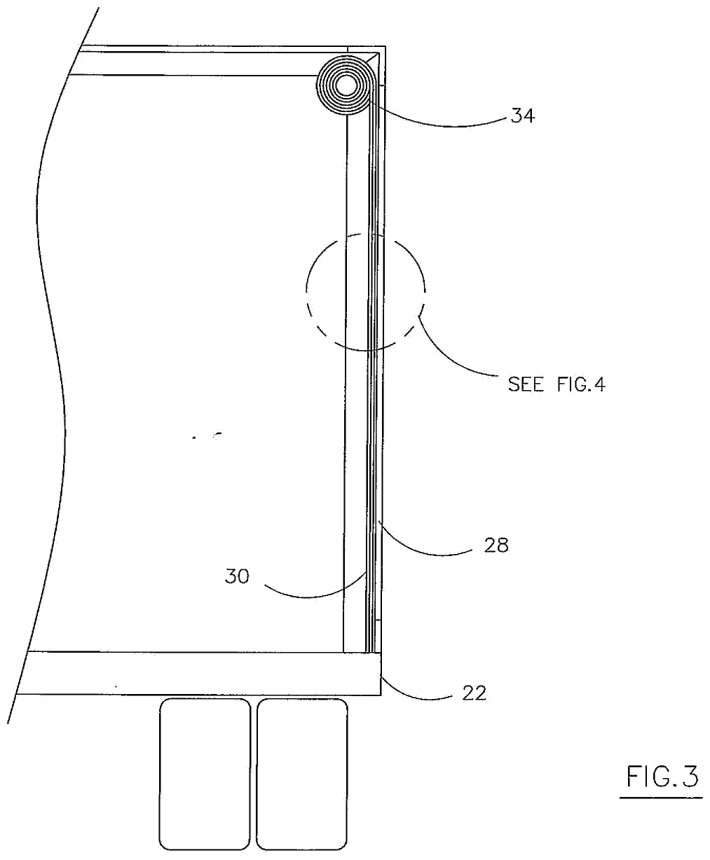

Although FIG. 3 demonstrates use of a gear motor 34 to raise and lower projection screen 30, it is further contemplated in the present invention that, in one embodiment, includes gear motor 34 constructed and arranged to raise and lower a flexible printed display 25.

The present invention provides significant novel advantages over currently used systems. Currently, trucks and other motor vehicles are either painted on the exterior or utilize canvas coverings that are significantly more difficult to use and have no features protecting the images from environmental damage.

In the system of the present invention, in an environment with a printed display 25 a projection screen 30, or combinations thereof, safety covering 28 protects the display from the elements.

In one environment, safety covering 28 further includes a coding to filter UV rays such that either of printed display 25 or projection screen 30 is protected from prolonged exposure to sunlight.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A system for mobile advertising comprising:
a display associated affixed to a side panel of a truck;
a cover positioned distal from said display, wherein in said cover is configured to protect said display from environmental damage; and
a control system including a control computer operatively associated with a projector configured for projecting an image on said display.

2. The system of claim 1 wherein said cover configured to protect said display from environmental damage is configured to prevent rainwater from touching said display.

3. The system of claim 1 wherein said cover configured to protect said display from environmental damage includes a UV coating for preventing damage due to prolonged sunlight exposure.

4. The system of claim 1 wherein said display is connected to a gear motor in a configuration that said display is rolled up or rolled down as desired.

5. The system of claim 1 wherein said control system is operatively associated with a mobile computing device.

6. The system of claim 1 wherein said image is changeable in real time by an operator accessing said control computer.

7. The system of claim 1 wherein said image is changeable in real time by an operator accessing said control computer by Wi-Fi, Bluetooth, or combinations thereof.

8. The system of claim 1 wherein said display includes 1-3 distinct images.

9. The system of claim 1 wherein location of said system is monitored by a GPS tracking system.

10. The system of claim 1 wherein said image is displayed on a high brightness display between 5500-6500 nits.

11. The system of claim 1 wherein said display further includes lighting about said display perimeter.

12. A system for mobile advertising comprising:
a removable display affixed to a side panel of a truck, said removable display having a permanent display image thereon; and
a cover positioned distal from said display, wherein in said cover is configured to protect said display from environmental damage.

13. The system of claim 12 wherein said cover configured to protect said display from environmental damage is configured to prevent rainwater from touching said display.

14. The system of claim 12 wherein said cover configured to protect said display from environmental damage includes a UV coating for preventing damage due to prolonged sunlight exposure.

15. The system of claim 12 wherein said display is connected to a gear motor in a configuration that said display is rolled up or rolled down as desired.

16. A system for mobile advertising consisting of:
a display associated affixed to a side panel of a truck;
a cover positioned distal from said display, wherein in said cover is configured to protect said display from environmental damage including rain and UV rays;
a control system including a control computer operatively associated with a projector configured for projecting an image on said display, whereby said control computer is accessed by an operator in real time utilizing any one or combination of hard wire, Wi-Fi, or Bluetooth, and said control computer configured for changing said image on said display in real time.
